(19) United States
(12) Patent Application Publication
(10) Pub. No.: US 2014/0044262 A1
(43) Pub. Date: Feb. 13, 2014

(54) Low Latency Encryption and Authentication in Optical Transport Networks

(71) Applicants: Gilberto Loprieno, Milano (IT); David McGrew, Poolesville, MD (US); Fabio Maino, Palo Alto, CA (US); Scott Fluhrer, North Attleboro, MA (US)

(72) Inventors: Gilberto Loprieno, Milano (IT); David McGrew, Poolesville, MD (US); Fabio Maino, Palo Alto, CA (US); Scott Fluhrer, North Attleboro, MA (US)

(73) Assignee: Cisco Technology, Inc., San Jose, CA (US)

(21) Appl. No.: 13/570,579

(22) Filed: Aug. 9, 2012

(51) Int. Cl. H04L 9/28

(52) U.S. Cl. 380/256

(57) ABSTRACT

Data to be transmitted across an Optical Transport Network (OTN) is encrypted with a non-malleable encryption algorithm. An authentication code configured to allow authentication of the data with a low latency encryption algorithm is generated. A packet is generated which is configured to be transferred across the OTN and contains the encrypted data and the authentication code. The packet is transmitted across the OTN. Non-malleable encryption, origin authentication, data integrity and anti-replay protection are provided for OTNs over Dense Wavelength Division Multiplexed (DWDM) links. In one example, XTS-AES encryption and GMAC authentication techniques are combined to secure OTN frames.

### TECHNICAL FIELD

The present disclosure relates to sending encrypted transmission across networks, and in particular, across optical transport networks.

### BACKGROUND

Optical transport networks (“OTNs”) are data networks comprised of optical elements connected by optical fiber links. OTNs are able to provide Dense Wavelength Division Multiplexed (DWDM) links to allow for high data rates, multiplexing, switching management, supervision, and survivability of optical channels of the signals they transport. Given their high data rates, OTNs are well suited for applications requiring large data transmissions across great distances.

OTNs deploy optical fibers over large geographical areas, often crossing national boarders to connect OTN nodes in different countries. At times, it is necessary for the optical fibers to be deployed across areas in which it is difficult to provide secure access to the fibers. Also, it will sometimes be necessary to deploy the fibers across unfriendly, or hostile territories. Given the large geographical area covered by OTNs, and the possibly unfriendly territory through which the fibers are deployed, OTNs may be exposed to eavesdroppers and hijackers. Additionally, given the high data rates of OTN networks, data security and authentication are particularly difficult to implement in OTN data transfers.

### BRIEF DESCRIPTION OF THE DRAWINGS

FIG. 1 is example block diagram of an optical transport network configured for low-latency encryption and authentication.

FIG. 2 is a flowchart illustrating a method of performing low latency encryption and authentication in an optical transport network.

FIG. 3 is flowchart for an example of fully non-malleable encryption.

FIG. 4 is a flowchart for an example of limited non-malleable encryption.

FIG. 5 is a flowchart for an example of partially non-malleable encryption.

FIG. 6 is a block diagram illustrating example encryption, authentication, and packetization logic.

FIG. 7 illustrates an example packet configured to be transferred across the optical transport network and containing encrypted data and an authentication code.

FIG. 8 is a flowchart illustrating a method of performing low latency decryption and authentication.

FIG. 9 is a block diagram illustrating example decryption and authentication logic.

FIG. 10 is a block diagram illustrating an example apparatus configured to perform non-malleable encryption and decryption and low latency authentication according to the techniques described herein.

### DESCRIPTION OF EXAMPLE EMBODIMENTS

### Overview

Data to be transmitted across an Optical Transport Network (OTN) is encrypted with a non-malleable encryption algorithm. An authentication code is generated to allow authentication of the data with a low latency encryption algorithm. A packet is generated that is configured to be transferred across the OTN and contains the encrypted data and the authentication code, and the packet is transmitted across the OTN. Analogous techniques are presented herein for decryption operations performed at the receive side.

### Example Embodiments

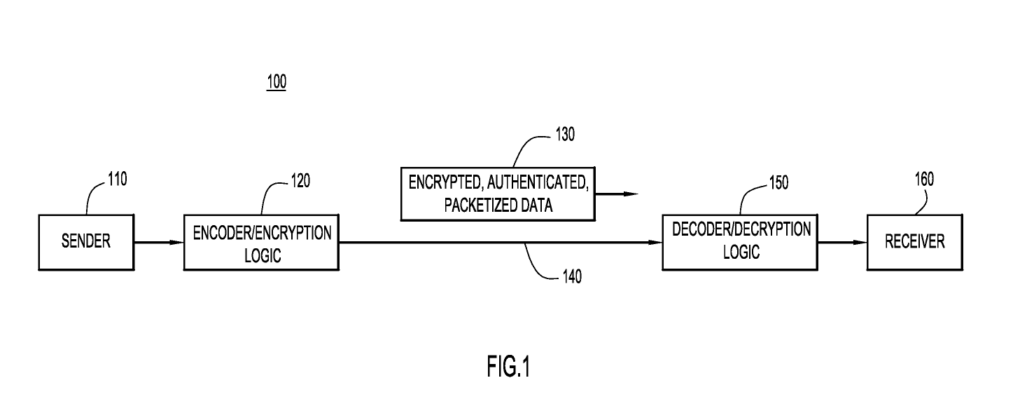

Referring first to FIG. 1, an example OTN 100 is shown across which packetized, encrypted and authenticated data is transmitted according to the techniques described herein. Sender 110 provides data to an encoder or encryption logic 120 for transport across the OTN 100. Once the data is received, the encryption logic 120 will encrypt the data according to a non-malleable encryption algorithm. The encryption logic 120 may also provide an authentication code which will allow authentication of the data upon decryption at, for example, decoder or decryption logic 150. Given the high data transfer rates of OTNs, the authentication code and method of authentication may be chosen such that the data may be efficiently pipelined at the decryption logic 150.

Upon completion of the encoding and providing of the authentication code, the encryption logic 120 generates a packet 130 for transmission across the OTN on one or more optical fibers 140. The packet 130 is received by decryption logic 150, decrypted and supplied to the receiver (intended destination) 160. More specifically, the decryption logic 150 will decrypt the non-malleably encrypted data. The decrypted data will be authenticated using the authentication code received in the data packet 130.

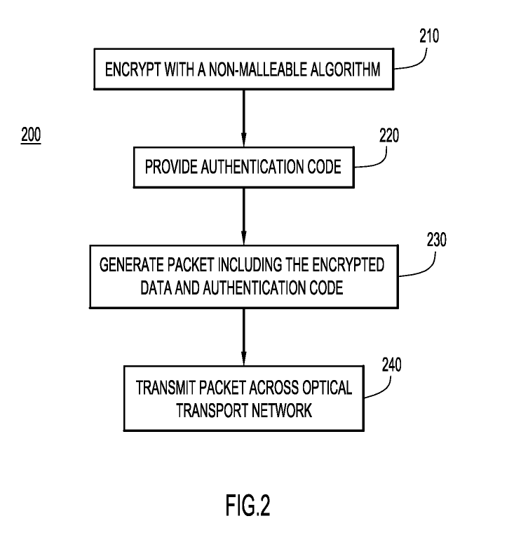

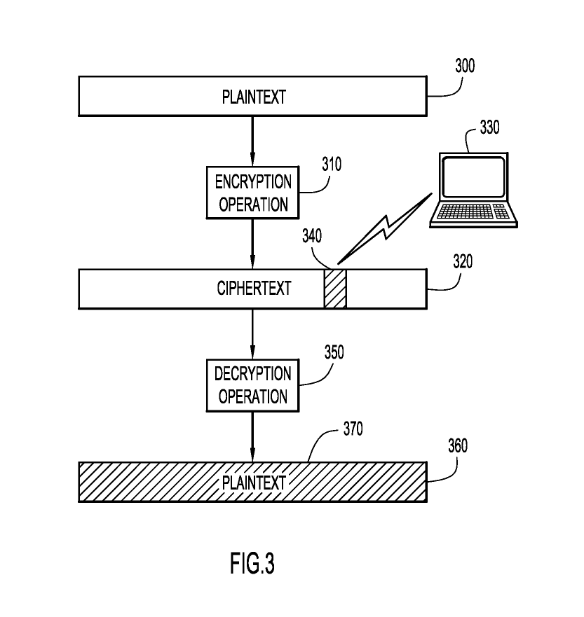

Turning to FIG. 2, depicted therein is a flowchart illustrating an example method 200 for transmitting encrypted and authenticated data across an OTN. The method begins in step 210 where data is encrypted with a non-malleable encryption algorithm. Examples of non-malleable encryption algorithms are described hereinafter with reference to FIGS. 3-5.

In step 220, an authentication code is provided for authentication of the data with a low latency authentication algorithm. For example, the authentication code may be included in the encrypted data, or alternatively, the authentication code may be provided separately from the data. According to various examples, the authentication code may take the form of a Galois Counter Mode (GCM) authentication code, or a Galois Message Authentication Code (GMAC). If the authentication code is included in the encrypted data, it may take the form of a string of predetermined characters, such as a string of zeros, or a checksum.

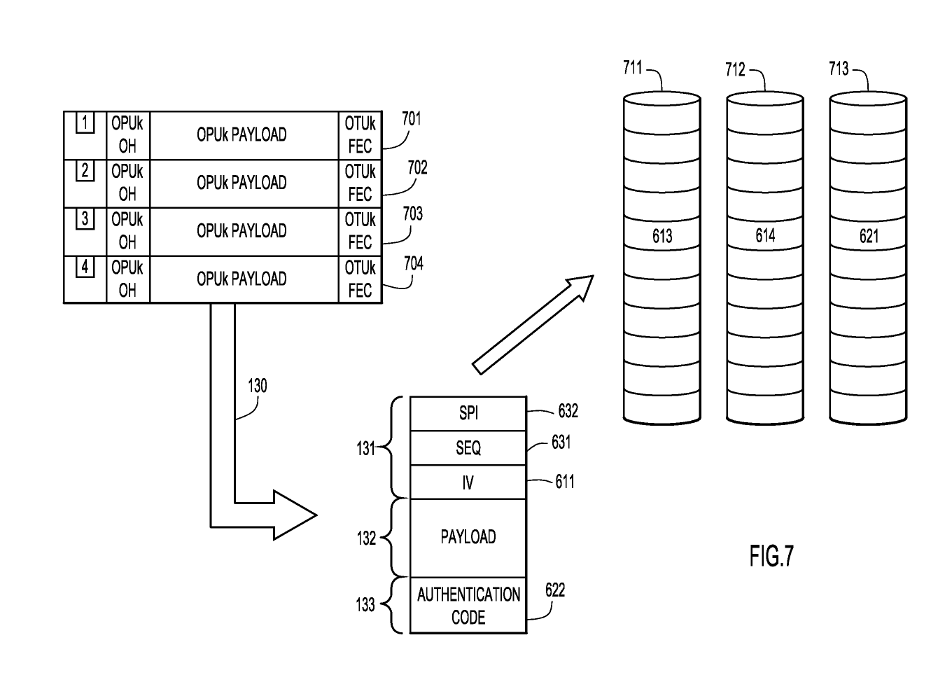

In step 230, a packet is generated that is configured to include the encrypted data and the authentication code. Examples of the packet generation operation will be described in greater detail below, in reference to FIG. 7. The method 200 completes at step 240 when the packet is transmitted across the OTN.

Reference is now made to FIG. 3 for a description of one example of a non-malleable encryption algorithm that may be used at 210 in the flowchart of FIG. 2. The encryption procedure depicted in FIG. 3 is referred to as a fully non-malleable encryption algorithm. Plaintext 300 is encrypted by a fully non-malleable encryption operation 310 in order to create encrypted ciphertext 320. The encrypted data may now be transferred across, for example, an OTN.

An attacker 330, though unable to decrypt cipher text 320, may attempt to cause predictable changes in the ciphertext 320 by, for example, flipping particular bits 340 of the cipher text. If the plaintext 300 is encrypted according to a malleable encryption algorithm, when the decryption operation 350 decrypts ciphertext 320, the attacker 330 may be able to insert predictable, malicious code into the plaintext 360. In contrast, if the encryption operation 310 uses a fully non-malleable encryption algorithm, any change 340 made by attacker 330 will result in the entirety 370 of decrypted plaintext 360 appearing as random or pseudo-random plaintext.

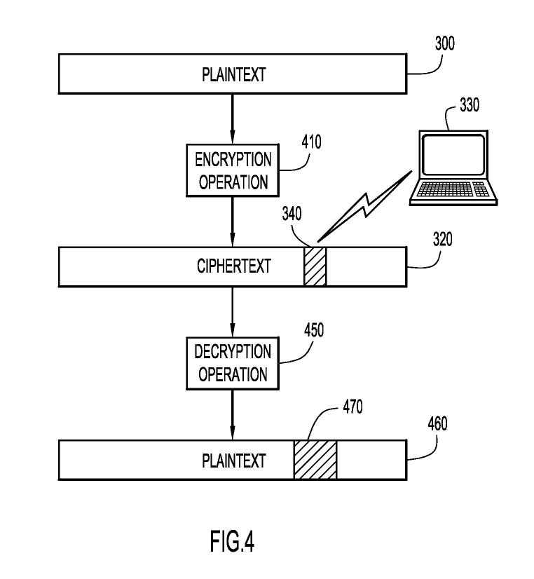

Next, with reference to FIG. 4, a flowchart is shown for an example of a limited non-malleable encryption. Limited non-malleable encryption is similar to fully non-malleable encryption in that a change 340 made by attacker 330 will result in a random or pseudo-random portion 470 of the plaintext 460 decrypted by decryption operation 450. However, the random or pseudo-random portion 470 will not be the entirety of plaintext 460, but will instead be a portion 470 corresponding to the portion 340 which was changed by the attacker 330.

A specific example of a limited non-malleable encryption algorithm is a ciphertext stealing (XTS) encryption algorithm, or more specifically, an XTS encryption algorithm implemented according to the Advanced Encryption Standard (AES). Even more specifically, the XTS-AES encryption may be implemented according to IEEE P1619.1 standard.

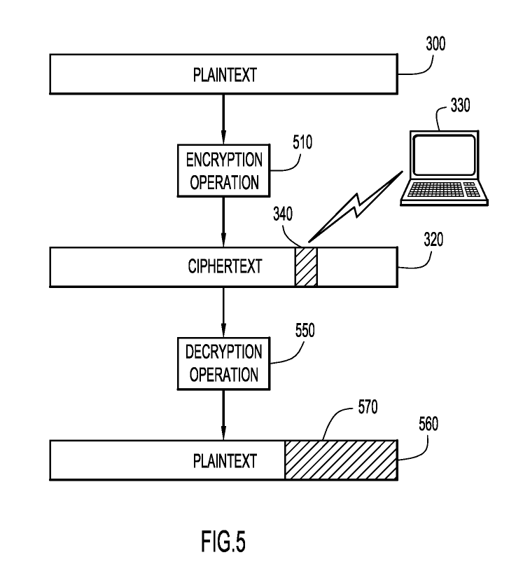

Turning now to FIG. 5, a flowchart for an example of a partially non-malleable encryption procedure is described. Partially non-malleable encryption is similar to fully non-malleable encryption and limited non-malleable encryption in that a change 340 made by attacker 330 will result in a random or pseudo-random portion 570 of the plaintext 560 decrypted by decryption operation 550. However, the random or pseudo-random portion 570 will not be the entirety of plaintext 560 as it would in fully non-malleable encryption. Furthermore, random or pseudo-random portion 570 will not be limited to a portion of the plaintext 560 corresponding to the portion in which change 340 was made. Instead, in a partially non-malleable encryption algorithm, the plaintext from the point corresponding to where the change 340 was made, through to the end of the plaintext 560 will be random or pseudo-random text 570.

A specific example of a partially non-malleable encryption is the block cipher mode of operation described in detail below.

Let P₁, P₂, . . . , Pₘεf{0; 1}^{w} denote plaintext blocks, and C₁, C₂, . . . ; Cₘε{0; 1}^{w} denote ciphertext blocks. Furthermore, let X₀, X₁, . . . ; Xₘ, Y₀, Y₁, . . . ; Yₘε{0; 1}^{w} be internal variables. P and C denote the plaintext and ciphertext, where P=P₁∥P₂∥ . . . ∥Pₘ and C=C₁∥C₂∥ . . . ∥Cₘ.

A·B and A [symbol] B denote multiplication and addition in GF(2^{w}), respectively. Note that addition and subtraction in GF(2^{w}) are identical. The encryption and decryption operations utilize three key values: A;Bε{0; 1}^{w}, and a block cipher key K. The encryption of a value Xε{0; 1}^{w} by the block cipher, using the key K, is denoted as E_{K}(X), and the decryption of X with the key K is denoted as E_{K}⁻¹ (X).

The full mode of operation is as follows. The encryption of a plaintext P using keys K, A, B is denoted as enc(K; A;B; P) and works as:

$${X}_{i} = \{ \begin{matrix}1 & for i = 0 \\ ( {X}_{i - 1} \cdot A ) ⊕ {P}_{i} & otherwise\end{matrix} \\ {Y}_{i} = \{ \begin{matrix}1 & for i = 0 \\ {E}_{K} ( {X}_{i} ) & otherwise\end{matrix} \\ {C}_{i} = ( {Y}_{i - 1} \cdot B ) ⊕ {Y}_{i}$$

The decryption of a ciphertext C using keys K, A, B is denoted as dec(K; A;B; P) and works as:

$${Y}_{i} = \{ \begin{matrix}1 & for i = 0 \\ ( {Y}_{i - 1} \cdot B ) ⊕ {C}_{i} & otherwise\end{matrix} \\ {X}_{i} = \{ \begin{matrix}1 & for i = 0 \\ {E}_{K}^{- 1} ( {Y}_{i} ) & otherwise\end{matrix} \\ {P}_{i} = ( {X}_{i - 1} \cdot A ) ⊕ {X}_{i}$$

Furthermore, let P, P′ be two distinct plaintexts, with j as the smallest index such that Pⱼ≠Pⱼ′. If we define:

δPᵢ=Pᵢ⊕Pᵢ′

δXᵢ=Xᵢ⊕Xᵢ′

δYᵢ=Yᵢ⊕Yᵢ′

δCᵢ=Cᵢ⊕Cᵢ′.

then, considering the encryption of P and P′, these variables are given by:

$$δ {X}_{i} = \{ \begin{matrix}0 & for i < j \\ ( δ {X}_{i - 1} ⊕ δ {P}_{i} ) \cdot A & otherwise\end{matrix} \\ δ {Y}_{i} = \{ \begin{matrix}0 & for i < j \\ E ( {X}_{i} ) ⊕ E ( {X}_{i} ⊕ δ {X}_{i} ) & otherwise\end{matrix} \\ δ {C}_{i} = \{ \begin{matrix}0 & for i < j \\ δ {Y}_{i} \cdot B ⊕ δ {Y}_{i - 1} & otherwise\end{matrix}$$

Similarly, for decryption, we let C, C′ be two distinct ciphertexts, and let j be the smallest index such that Cⱼ≠Cⱼ′, the above listed variables are given by:

$$δ {Y}_{i} = \{ \begin{matrix}0 & for i < j \\ ( δ {Y}_{i - 1} ⊕ δ {C}_{i} ) \cdot B & otherwise\end{matrix} \\ δ {X}_{i} = \{ \begin{matrix}0 & for i < j \\ {E}_{K}^{- 1} ( {Y}_{i} ) ⊕ {E}_{K}^{- 1} ( {Y}_{i} ⊕ δ {Y}_{i} ) & otherwise\end{matrix} \\ δ {P}_{i} = δ {X}_{i} \cdot {A}^{- 1} ⊕ δ {X}_{i - 1} .$$

As can be seen from the above, if an attacker modifies block j of a valid ciphertext C (and possibly other blocks after that one), resulting in a bogus ciphertext C′, then the post-decryption plaintext blocks following the changed block will be different, and will be pseudorandom. In other words, and with reference to FIG. 5, if the attacker modifies a portion 340 of the plaintext 320, the post decryption plaintext 560 will include pseudo-random portion 570 from the point in plaintext 560 corresponding to where the change 340 was made in ciphertext 320 through the end of plaintext 560. The partial non-malleability property comes from the fact that the internal variable Xᵢ depends on both Xᵢ₋₁ and the secret key A, and thus Xᵢ depends on X₀, X₁, . . . , Xᵢ₋₁ in a way that is unpredictable to an attacker. Similarly, the internal variable Yᵢ depends on both Yᵢ₋₁ and the secret key B, and thus Yᵢ depends on Y₀, Y₁, . . . , Yᵢ₋₁ in a way that is unpredictable to an attacker. In other words, the encoding of each plaintext block depends from the values in each of the previously encrypted plaintext blocks. Accordingly, if a change is made to one plaintext block, every subsequent plaintext block will also be affected. The particular method of finite field multiplication used in the description above is simple and efficient, though other methods may result in partial non-malleability.

As explained above, the encryption operation can only be applied to plaintexts that are block-aligned. Nevertheless, partially non-malleable encryption can be extended so that it can handle non-aligned plaintexts, through mechanisms, such as block padding. For example, one suitable method is to append to the plaintext a single bit equal to one, followed by enough zero bits to fill out the block; if the message ends on a block boundary, a whole block of zeros is added. The encryption operation can also be extended so that it provides authentication on additional data that is associated with the message that is being encrypted. This can be done by adapting the encryption operation so that the initial variables X₀ and Y₀ depend on the associated data and on a secret key.

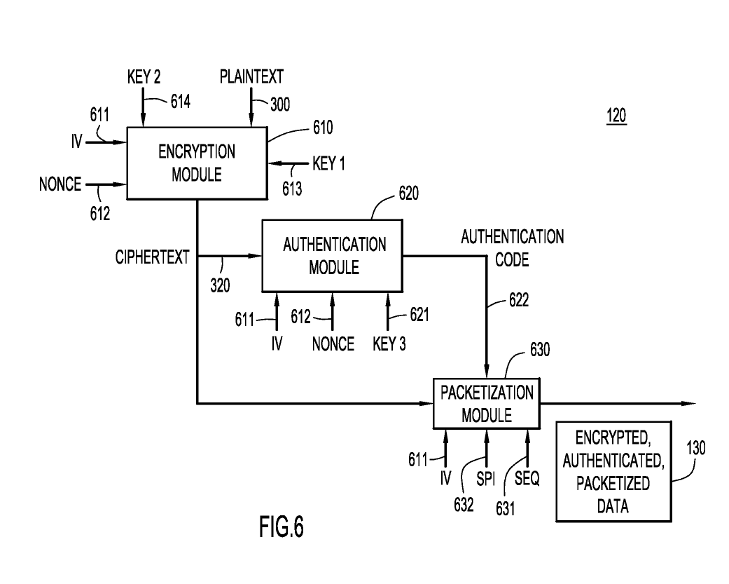

Reference is now made to FIG. 6, which illustrates an example block diagram of encryption logic 120 configured to provide non-malleable encryption and an authentication code to allow for authentication of the data with a low latency authentication algorithm. In FIG. 6, encryption module 610 receives an initialization vector 611, a nonce 612, a first key 613, a second key 614, and the plaintext 300 to be encrypted as ciphertext 320. Encryption module 610 may perform any one of non-malleable encryption, limited non-malleable encryption (such as XTS-AES), and partially non-malleable encryption (such as encryption based on a block cipher mode of operation) on the plaintext 300.

While FIG. 6 shows the encryption module 610 receiving two keys, first key 613 and second key 614, in other examples, encryption module 610 may received more or fewer keys depending on the type of encryption that is being applied to the plaintext 300. For example, as discussed above, encryption based upon a block cipher mode of operation may utilize three separate keys, keys A and B and block cipher key K.

After encryption has been applied to plaintext 615, encryption module 610 outputs ciphertext 320. In the example depicted in FIG. 6, ciphertext 320 passes on to both authentication module 620 and packetization module 630.

Authentication module 620 receives ciphertext 320 in order to provide an authentication code 622 to allow for authentication of the data with a low latency authentication algorithm. Authentication module 620 also receives initialization vector 611, nonce 612 and third key 621. According to the exampled depicted in FIG. 6, the initialization vector 611 and nonce 612 are the same initialization vector 611 and nonce 612 provided to encryption module 610. The initialization vector 611 used to encrypt the plaintext 300 shifts every 128 bits in the authentication module 620.

The authentication code 622 provided by the authentication module 620 may be, for example, a GMAC authentication code. A GMAC authentication code can be efficiently pipelined at the decoder/decryption logic, and therefore, may operate at speeds sufficient to meet the needs of the OTN data rates.

The authentication module 620 may be incorporated within the encryption module 610. For example, if partially non-malleable encryption is being applied to the plaintext 300, the authentication code 622 may take the form of a string of characters, such as a string of zeros, or a checksum. According to this example, the authentication code 622 may be appended to the end of the plaintext 300. When the ciphertext 320 is transmitted across the OTN without any changes by an attacker, upon decryption, the authentication code 622 will appear as the expected string of characters or checksum. Alternatively, if a change is made to the ciphertext 320, the authentication code 622 will no longer be the expected string of characters or checksum, but will instead appear as random or pseudo-random plaintext.

Once the authentication code 622 is provided, it is passed to packetization module 630. According to the example depicted in FIG. 6, packetization module 630 receives the ciphertext 320, the authentication code 622, initialization vector 611, security parameter index 632, and sequence number 631. In the example shown in FIG. 6, the initialization vector 611 is the same initialization vector provided to the encryption module 610 and authentication module 620. The packetization module 630 generates packet 130 configured to be transmitted across an OTN. The packet 130 includes the encrypted data, or ciphertext 320, and the authentication code 622.

While FIG. 6 depicts the encryption module 610, the authentication module 620, and the packetization module 630 as three distinct components, it should be understood that the encryption module 610, the authentication module 620, and the packetization module 630 may be embodied in more or fewer components. For example, when implementing partially non-malleable encryption and using a predetermined string of characters as an authentication code 622, the encryption module 610 may serve as both the encryption module 610 and the authentication module 620.

Turning now to FIG. 7, an example of packet 130 is described in greater detail. Packet 130 comprises a header 131, a payload portion 132 and a tailer 133. The header 131 may comprise an encapsulated security payload header 131, and included within the header 131 are values such as security parameter index 632, sequence number 631 and initialization vector 611.

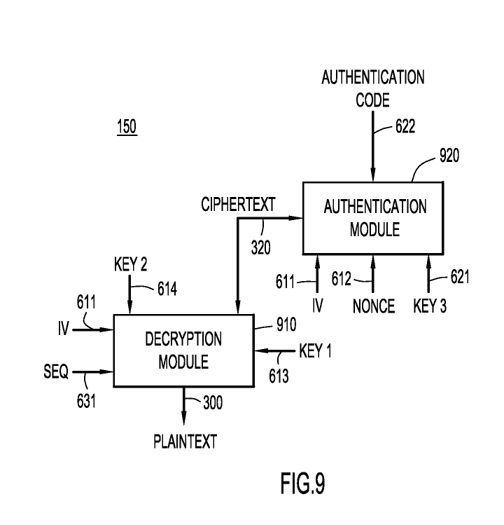

The initialization vector 611 may be used as the initialization vector for both the non-malleable encryption and the low-latency authentication algorithm. For example, the initialization vector operates as a 64-bit linear feedback shift register, which shifts for every 128 bits of payload. Accordingly, as described above in reference to FIG. 6, the initialization vector used to encrypt the plaintext 300 will shift every 128 bits. Similarly, as described below in reference to FIG. 9, the decryption module will shift the initialization vector 611 every 128 bits. Analogous shifting of the initialization vector will take place in the authentication module 920 of FIG. 9.

Payload portion 132 may comprise the data of, for example, four OTN frames 701-704. According to this example, the payload portion 132 may be very large. Specific examples may include payload portions 132 which have 60928 bytes of data, or more. Or course, the payload portions 132 may contain less data.

The tailer portion 133 comprises an encapsulated security payload tailer which includes authentication code 622. In other examples, such as those implementing partially non-malleable encryption and which use a predetermined string of characters as an authentication code 622, the authentication code 622 may be included in the encrypted data of the payload portion 132.

As shown in FIG. 7, the security parameter index 632 may be used as the key index to select the appropriate first key 613, second key 614 and third key 621 from a first master key 711, a second master key 712, and a third master key 713, respectively. Example master keys 711-713 may each comprise 64 256-bits keys. Accordingly, the parameter index 632 will indicate which of the 64 keys should used to perform the encryption and decryption of the data.

Sequence number 631 is used to both generate the authentication code 622, and to authenticate the data once the data reaches the receiver. The sequence number is a sequential value that is incremented every packet, and is set to zero when the key is changed. Accordingly, the sequence number will be incremented for every 128 bits of payload during the generation of the authentication code 622, and during authentication at the receiver.

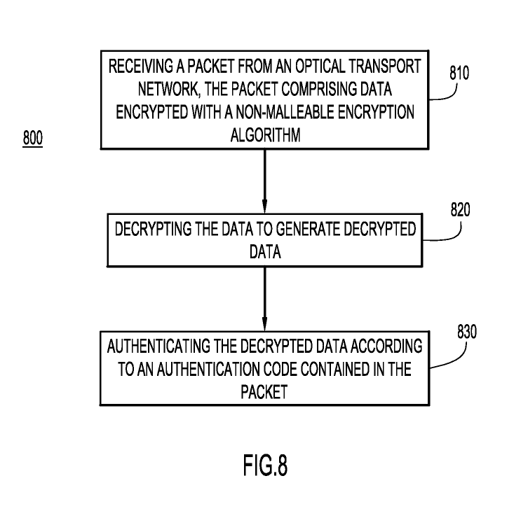

Referring now to FIG. 8, a flowchart is now described for an example method 800 of decrypting data received in a packet that has been encrypted with a non-malleable encryption algorithm. The method begins in step 810 where a packet is received from an OTN. The packet data has been encrypted according to a non-malleable encryption algorithm, and the packet may include an authentication code.

In step 820, the encrypted data is decrypted to generate decrypted data. The decryption operation may be performed according to a fully non-malleable algorithm, a limited non-malleable algorithm such as XTS-AES, or a partially non-malleable algorithm, such as the block cipher mode of operation described above.

In step 830, the decrypted data is authenticated using an authentication code contained in the packet. The authentication may comprise evaluating the encrypted data to determine whether any changes were made. For example, the encrypted data may undergo the same authentication process that was completed by the sender of the data. If the authentication code determined by the receiver is the same as the authentication code sent in the packet, it may be determined that the received encrypted data is the same as the encrypted data that was sent by the sender, i.e., the data is authenticated. Alternatively, authenticating may involve evaluating the decrypted data. For example, when the received data has been encrypted according to a partially non-malleable algorithm, authenticating the data in step 830 may comprise evaluating the decrypted data to determine if a predetermined string of characters is present in the decrypted data. If the predetermined string of characters is present in the data, it may be determined that the encrypted data received in step 810 is the same encrypted data that was originally sent.

Turning now to FIG. 9, depicted therein is a block diagram of decryption logic 150 configured to decrypt data encrypted according to a non-malleable encryption algorithm, and to authenticate the decrypted data according to an authentication algorithm that can be efficiently pipelined. Decryption logic 150 includes decryption module 910. Decryption module 910 receives the ciphertext included in the payload portion of the received encrypted packet, an initialization vector 611 included in the received packet header, sequence number 631 included in the received packet header, and first and second keys 613 and 614, respectively. The first and second keys may not be received in the packet. Instead, a security parameter index 632 may be included in the received packet header. The security parameter index 632 may then be used as the key index to select the appropriate first key 613 and second key 614 from first master key 711 and second master key 712, respectively. Through the use of the initialization vector 611, the sequence number 631, the first key 613, and the second key 614, decryption module 910 may produce decrypted plaintext 360.

While FIG. 9 shows the decryption module 910 receiving two keys, first key 613 and second key 614, the decryption module 910 may received more or fewer keys depending on the type of encryption that has been applied to the ciphertext 320. For example, as discussed above, encryption based upon a block cipher mode of operation that uses three separate keys, keys A and B and block cipher key K.

The authentication module 920 shown in FIG. 9 may be configured to authenticate the decrypted data 360. The authentication module 920 receives ciphertext 320, authentication code 622, initialization vector 611, nonce 612, and third key 621. The initialization vector 611 may be the same initialization vector used to perform the decryption in decryption module 910, and may be included in the received packet header. Third key 621 may not be included in the received packet header, but may instead be selected from a third master key 713. The third key 621 may be selected according to a security parameter index 632 included in the received packet header. The security parameter index 632 used to select the first key 613 and second key 614 may be the same security parameter index 632 used to select third key 621. Authentication module 920 may also receive authentication code 622 included in the received packet tailer.

The authentication module 920 may perform the same authentication on ciphertext 320 that was performed by the sender of the packet. The authentication module 920 may then compare the results of the authentication with the received authentication code 622. If the authentication performed at authentication module 920 results in the same authentication code as received authentication code 622, it may be determined that the received ciphertext 320 is the same as the ciphertext sent by the sender.

In another example, authentication module 920 may receive the decrypted plaintext 360 instead of ciphertext 320. For example, if the ciphertext 320 has been encrypted accordingly to a partially non-malleable encryption algorithm, and the authentication code 622 comprises a predetermined string of characters, authentication module 920 may receive decrypted plaintext 360 to determine if the predetermined string of characters is present at the end of the plaintext 360. If the predetermined string of characters is present at the end of plaintext 360, it may be determined that the received ciphertext 320 is the same as the ciphertext sent by the sender.

The authentication module 920 may also control whether or not data should be received from a specific connection. For example, as the authentication module 920 detects authentication failures, after a threshold number of failures is met (typically a low number such as four), the authentication module 920 may indicate that the receiver should stop accepting data across the connection until new master keys 711-713 (FIG. 7) are established. The threshold may be flexible, and allow widely spaced individual authentication failures, while not tolerating frequent failures.

While FIG. 9 depicts the decryption module 910 and the authentication module 920 as two distinct components, it should be understood that the encryption module 910 and the authentication module 920 may be embodied in more or fewer components. For example, when implementing partially non-malleable encryption and using a predetermined string of characters as an authentication code 622, the decryption module 910 may serve as both the decryption module 910 and the authentication module 920.

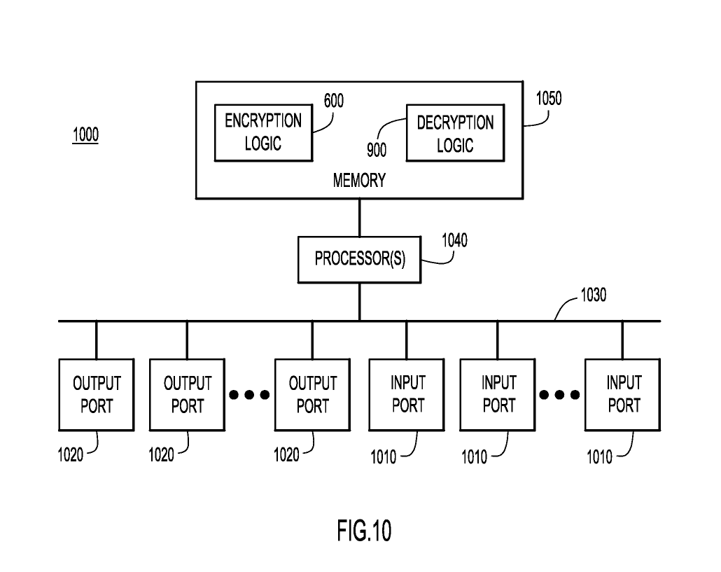

Reference is now made to FIG. 10. FIG. 10 illustrates an example block diagram of an apparatus 1000 configured to perform the encryption and decryption techniques described herein. Thus, the apparatus 1000 may serve as a sending device and a receiving device of a communication link over an OTN (as depicted in FIG. 1). The apparatus 1000 comprises one or more input ports 1010 are configured to receive optical signals on optical fibers and convert the optical signals to digital electrical signals for decryption processing. There are one or more output ports 1020 configured to convert encrypted digital electrical signals to optical signals for transmission across an optical fiber. The input ports 1010 and output ports 1020 are coupled to a bus 1030. A processor 1040 is provided for overall control of the apparatus 1000. The processor 104 is, for example, a microprocessor or microcontroller. Memory 1050 is provided to store software instructions that may be executed by the processor 1040.

Memory 1050 may comprise read only memory (ROM), random access memory (RAM), magnetic disk storage media devices, optical storage media devices, flash memory devices, electrical, optical or other physical/tangible (e.g. non-transitory) memory storage devices. Thus, in general, the memory 1050 may comprise one or more tangible (non-transitory) computer readable storage media (e.g., a memory device) encoded with software comprising computer executable instructions.

The encryption logic 120 and/or decryption logic 150 may be embodied as software instructions stored in memory 1050 and executed by processor 1040 to perform the operations described herein in connection with FIGS. 1-9. Alternatively, encryption logic 120 and/or decryption logic 150 may be implemented in hardware, such as by digital logic gates in one or more application specific integrated circuits or in programmable logic, such as in one or more field programmable gate arrays (FPGAs).

There are several advantages to the techniques described herein. Specifically, through the use of non-malleable encryption, origin authentication, data integrity and anti-replay protection may be provided for OTNs over DWDM links. For example, by using fully, limited and partially non-malleable encryption algorithms, data that has been modified by an attacker may be discarded by the decryption module. However, the use of non-malleable encryption ensures that the attacker cannot manipulate the data to be a non-arbitrary value. While using fully non-malleable encryption will provide exceptional data integrity protection, it may result in higher latency at the receiver than limited and partially non-malleable encryption.

By using limit malleable encryption, such as XTS-AES encryption, and partially non-malleable encryption, such as encryption with the block cipher mode of operation described above, in conjunction with a low latency authentication algorithm, such as GMC or GMAC, a low latency secure scheme appropriate for OTN networks may be provided.

Authentication algorithms may be chosen to achieve specific benefits. For example, if it is beneficial to reduce gate count, GMAC authentication may be chosen. If very simple authentication is desired, a predetermined string of characters may be used as an authentication code for partially non-malleable encryption.

Furthermore, when, for example, XTS-AES encryption is combined with GMAC authentication, computations may be simplified by transporting the initialization vector, sequence number and security parameter index at least one frame in advance of the encrypted data. This allows for pre-computation of AES for GMAC, and one AES block for XTS. Furthermore, because the same initialization vector is used for both the encryption/decryption and authentication, a packet may be efficiently constructed and transmitted.

The above description is intended by way of example only.

What is claimed is:

1. A method comprising:
encrypting data with a non-malleable encryption algorithm to be transmitted across an Optical Transport Network (OTN);
generating an authentication code configured to allow for authentication of the data with a low latency authentication algorithm;
generating a packet configured to be transmitted across the OTN, the packet including the encrypted data and the authentication code; and
transmitting the packet across the OTN.

2. The method of claim 1, wherein generating comprises packetizing data for a plurality of OTN frame payloads.

3. The method of claim 1, wherein generating the authentication code comprises using an algorithm to generate the authentication code so that the low latency authentication algorithm can be efficiently pipelined at a decoder after the packet is received from the OTN.

4. The method of claim 1, wherein generating the packet comprises generating a packet header comprising an initialization vector (IV), a security parameter index (SPI) and a sequence number (SEQ), wherein the IV is configured to be used as an IV to decrypt and authenticate the encrypted data, and wherein the SPI is configured to be used as an SPI to decrypt and authenticate the encrypted data, and wherein the SEQ is configured to be used to authenticate the encrypted data.

5. The method of claim 1, wherein encrypting comprises encrypting using a limited non-malleable encryption algorithm.

6. The method of claim 5, wherein the limited non-malleable encryption algorithm comprises a ciphertext stealing (XTS) encryption algorithm.

7. The method of claim 5, wherein generating the authentication code comprises using a Galois Message Authentication Code (GMAC) authentication algorithm.

8. The method of claim 1, wherein encrypting comprises encrypting using a partially non-malleable encryption algorithm.

9. The method of claim 8, wherein the partially non-malleable encryption algorithm is a block cipher encryption algorithm.

10. The method of claim 9, wherein the block cipher encryption algorithm encrypts a current plaintext block based upon previously encrypted plaintext blocks.

11. The method of claim 8, wherein generating the authentication code comprises generating a predetermined string of characters at a tail-end of the data prior to encryption.

12. The method of claim 11, wherein the predetermined string of characters comprises a string of zeros.

13. The method of claim 8, wherein generating the authentication code comprises generating a checksum.

14. An apparatus comprising:
at least one port configured to interface with an Optical Transport Network (OTN);
a memory; and
a processor coupled to the memory and the at least one port, wherein the processor is configured to:
encrypt data of an OTN frame with a non-malleable encryption algorithm;
generate an authentication code configured to allow authentication of the data with a low latency authentication algorithm;
generate a packet configured to be transmitted across the OTN, the packet including the encrypted data and the authentication code; and
transmit the packet across the OTN via the port.

15. The apparatus of claim 14, wherein the processor is further configured to encrypt data with a limited non-malleable encryption algorithm.

16. The apparatus of claim 15, wherein the processor is further configured to generate the authentication code using a Galois Message Authentication Code (GMAC) authentication algorithm.

17. The apparatus of claim 14, wherein the processor is further configured to encrypt data with a partially non-malleable encryption algorithm.

18. The apparatus of claim 17, wherein the processor is further configured to generate the authentication code using a predetermined string of characters.

19. A computer readable tangible storage media encoded with instructions that, when executed by a processor, cause the processor to:
encrypt data with a non-malleable encryption algorithm to be transmitted across an Optical Transport Network (OTN);
provide an authentication code configured to allow for authentication of the data with a low latency authentication algorithm; and
generate a packet configured to be transmitted across the OTN, the packet including the encrypted data and the authentication code.

20. The computer readable tangible storage media of claim 19, wherein the instructions that cause the processor to encrypt comprise instructions that cause the processor to encrypt the data with a limited non-malleable encryption algorithm.

21. The computer readable tangible storage media of claim 19, wherein the instructions that cause the processor to encrypt comprise instructions that cause the processor to encrypt the data with a partially non-malleable encryption algorithm.
